(19) United States
(12) Patent Application Publication
(10) Pub. No.: US 2018/0365776 A1
(43) Pub. Date: Dec. 20, 2018

(54) ONLINE ENERGY AUDIT SYSTEM

(71) Applicant: E M INTELLIGENCE LIMITED, Hong Kong (CN)

(72) Inventor: Chau Leung Tory CHAN, Hong Kong (CN)

(21) Appl. No.: 16/060,222

(22) PCT Filed: Oct. 11, 2017
(86) PCT No.: PCT/IB2017/056271

§ 371 Date: Jun. 7, 2018

(30) Foreign Application Priority Data
Oct. 14, 2016 (HK) 16111924.0

(51) Int. Cl. G06Q 50/06; H04L 29/08; H04L 29/06; G05B 15/02

(52) U.S. Cl. CPC G06Q 50/06; G05B 15/02; H04L 69/16; H04L 67/12

(57) ABSTRACT

An online energy audit system based on Electromechanical to Internet of Things (EM2IoT) and for use in a building, comprising at least one versatile device and data management unit (DMU) adapted and configured for connecting, interacting, intercommunicating with each of energy metering devices, energy consuming devices, and/or environmental sensors installed in the building and manipulating first data received and transmitted therebetween by making use protocols including RS232, RS485, MODBUS, RTU, BACnet, Lonworks, KNX, M-BUS, and/or CAN; and for outputting and sending a second data derived from the first data in a dedicated format with TCP/IP protocol and/or UDP/IP protocol to a remote server or control management apparatus for performing system control and data analysis operations for enabling an online and real-time energy audit for the building.

### TECHNICAL FIELD

The present disclosure relates to online energy audit systems, and more particularly, to an online energy audit system and method based on Electromechanical to Internet of Things (EM2IoT) and making use of electromechanical devices, IoT, and bridging/interconnecting devices, such as a versatile device/data management unit (DMU) connected therebetween.

### BACKGROUND ART

The traditional energy audit was a formal examination process comprising identification of every energy consuming device in a facility, determination of rate of energy consumption of the device and the number of hours the device operates in a period of 24-hours. The energy audit is also known as an inspection, survey and analysis process for energy flows, energy conservation in a building, or a processing system to reduce the amount of energy input without negatively affecting the output. In a commercial and industrial real estate, the energy audit is employed as the first step in identifying opportunities to reduce energy expense and carbon footprints.

Presently, the energy audit was performed by manual data recording of each of the buildings devices for generation of annual energy bill and energy consumption pattern (by referring to manual, log sheet, name plate, interview), or the like; and taking measurements for motor survey, insulation, and lighting survey with portable instruments for collection of additional and accurate data. Thereafter, performing confirmation and comparison of operating data and design data. Generally, the energy audit is performed once per year or 2-3 years for conforming to the international standard. When the energy audit was done (normally the audit report will be issued after 3-9 months), all the measurement devices must be removed from the building. So it waste the installation manpower and material, also it will not provide the most updated information and data. Therefore, it requires improvement on the collection of the entire building's devices data and an online data control is desirable. It is also desirable to realize the measuring, controlling, recording and management functions of entire building's devices. However, the building's devices such as sensors for temperature, humidity, pressure, door, CO2, and water flood; and flood probes; access meters for water, gas, electricity, and heat; machinery monitors for dry contacts, PLC—programmed logic controller; I/O devices for buttons and indicators, such as lighting, etc; air conditioning control comprising motorize valve, fan coil unit, AHU, PAU, etc, have various output of various data format, such as RS232, RS485, MODBUS, RTU, BACnet, Lonworks, KNX, M-BUS, or CAN bus, etc; and some of them are even operated without any data output interface supported by the building's devices. Therefore they need to be recorded by manual at different locations and at different time. However, unreliable artificial factors exist in the data exchange between different locations at different time. There are difficulties in data transcription, and inconvenience in use of several parts of the energy auditor, and the data might not be provided for real time online access and control. The disadvantage of prior art method is that they need a lot of manpower for installation of the measuring devices and cannot get the various data at the same time for performing energy analysis to compare the status at different locations and under different conditions. It can only calculate the average result for a preset period and needs to input again all the data by manual into the computer system to calculate again. There might be some typing errors occurred during the process. In addition, they need to uninstall all the measuring devices after finishing the energy audit of the building, which will waste time, money and material again and again.

In addition, there are various online reading building's devices and online control system in the market, such as Building Energy Management Systems (BEMSs); Building Management System (BMS); Building Automation System (BA/BAS); Digital Data Control (DDC); Network and IP Thermostats; Intelligent Building Management System (iBMS); Integrated Building Management System (IBMS); Device Gateway; Wireless Device Gateway; IoT Device Gateway and Intelligent Device Gateway; and the like.

But most of them can only connect with 1 kind of devices, they cannot integrate with different kinds of devices, such as sensors for temperature, humidity, pressure, door, CO2, water flood; and flood probes; access meters for water, gas, electricity, heat; machinery monitors for dry contacts, PLC—programmed logic controller; I/O devices for buttons and indicators, such as lighting, etc; air conditioning control comprising motorize valve, fan coil unit, AHU, PAU, etc; energy consumption metering/billing devices, and the like. They do not support transmission with different protocols, such as RS232, RS485, MODBUS, RTU, BACnet, Lonworks, KNX, M-BUS, or CAN bus, etc.

### BRIEF SUMMARY OF INVENTION

The present invention is aiming at solving the aforementioned defects by providing an IoT/EM2IoT type intelligent DMU (Device/Data Management Unit) and its control system based on transmission of IoT/EM2IoT for implementing a fully automatic Building/Property Online Energy Audit and Control Management System; and the method for operating the system.

To this end, there is disclosed an online energy audit system based on Electromechanical to Internet of Things (EM2IoT) and for use in a building, comprising at least one versatile device and data management unit (DMU) adapted and configured for connecting, interacting, intercommunicating with each of energy metering devices, energy consuming devices, and/or environmental sensors installed in the building and manipulating first data received and transmitted therebetween by making use protocols including RS232, RS485, MODBUS, RTU, BACnet, Lonworks, KNX, M-BUS, and/or CAN; and for outputting and sending a second data derived from the first data in a dedicated format with TCP/IP protocol and/or UDP/IP protocol to a remote server or control management apparatus for performing system control and data analysis operations for enabling an online and real-time energy audit for the building.

In some embodiments, the energy metering devices comprise metering devices for water, gas, electricity, and/or heat; and/or the energy consuming devices comprise machinery monitoring devices including dry contacts, programmed logic controller; I/O devices for buttons and indicators including lighting; air conditioning control devices including motorize valve, fan coil unit, AHU, PAU; and/or the environmental sensors comprise sensors for temperature, humidity, pressure, door, CO2, water flood, and flood probes.

In some embodiments, the DMU comprises two MPUs respectively for network management and for data and command processing; and a main control chip adopting IAP technology of single-chip; and a built-in RAM and/or FLASH type data storage device for speeding up data processing and/or storing IP address/ID of each of connected devices or sensors, user ID, user password, energy audit related data, time, command, system log, error code or information, schedule, working conditions, operation, database for backup and restore.

In some other embodiments, the DMU comprises a ID controller configured for enabling an automatic or manual assignment of IP address and/or ID to each of connected energy metering devices, energy consuming devices, and/or environmental sensors, with or without RS485 device gateway converter.

In some embodiments, the DMU is configured for connecting concurrently a plurality of energy metering devices, energy consuming devices, and/or environmental sensors for collecting data concurrently from multiple devices and/or sensors of various IP addresses, IDs, and protocols for enhancing data accuracy and analysis base thereon.

In some embodiments, further comprising a data hub/data transmission module connected to the remote server or control management apparatus and connected directly and/or indirectly to each of connected energy metering devices, energy consuming devices, and/or environmental sensors via the DMU; the data transmission module receives a control signal from the remote server or control management apparatus and feeds back the second data and/or an information of data, status and command, in relation to each of connected energy metering devices, energy consuming devices, and/or environmental sensors, generated and sent by the DMU to the remote server or control management apparatus.

In some embodiments, the second data is encoded by a configurable cipher key stored in the DMU; when the cipher key is changed, the remote server or control management apparatus will send a packed command for modification of the cipher key to DMU, and the packed command will be unpacked and reverted to an operable command of the DMU for modification of the cipher key by the data hub/data transmission module or the DMU.

In some embodiments, the DMU is configured for converting each of connected energy metering devices, energy consuming devices, and/or environmental sensors into a thing or node of an Internet of Things (IoT) comprising the remote server or control management apparatus and the DMU, wherein the thing or the node is able to transfer the second data or an energy audit related data to the remote server or control management apparatus without requiring human-to-human or human-to-computer interaction.

In some embodiments, the DMU and each of its connected devices and sensors is configured as a node of an Internet of Things (IoT) comprising the remote server or control management apparatus, the data hub/data transmission module, and the DMU, wherein the node is connected to the data hub/data transmission module and transmits the second data or energy audit related data to the data hub/data transmission module; after collecting or receiving data from multiple nodes, the data hub/data transmission module transmits received data to the remote server or control management apparatus in a wired or wireless manner, preferably by optical fiber broadband interface, ADSL interface, and/or mobile interface including GPRS, 3G, and 4G interface.

### BRIEF DESCRIPTION OF DRAWINGS

The disclosure will be described by way of example with reference to the accompanying drawings, in which:

FIG. 1 is a block diagram of an example online energy audit system of the present disclosure;

FIG. 2 is a block diagram of an example DMU and its features or functional aspect of the example online energy audit system of the present disclosure;

FIG. 3 is a schematic view of a lighting ID controller (VC) connected indirectly with DMU of an example online energy audit system of the present disclosure;

FIG. 4 is a schematic view of a power ID controller (VC) connected indirectly with DMU of an example online energy audit system of the present disclosure;

FIG. 5 is a schematic view of a power ID controller (VC) connected directly with DMU of an example online energy audit system of the present disclosure;

FIG. 6 is a wiring diagram of an example DMU of the present disclosure;

FIG. 7 is a schematic view of PCB Main Board of an example DMU of the present disclosure;

FIG. 8 is a schematic view of PCB Sub-1 Board of an example DMU of the present disclosure;

FIG. 9 is a schematic view of PCB Sub-2 Board of an example DMU of the present disclosure; and

FIG. 10 is a schematic view of PCB boards of an example DMU of the present disclosure.

### DETAILED DESCRIPTION OF INVENTION

Some preferred embodiments of the present disclosure are set forth below in conjunction with the accompanying drawings, so as to illustrate in details the technical solutions thereof.

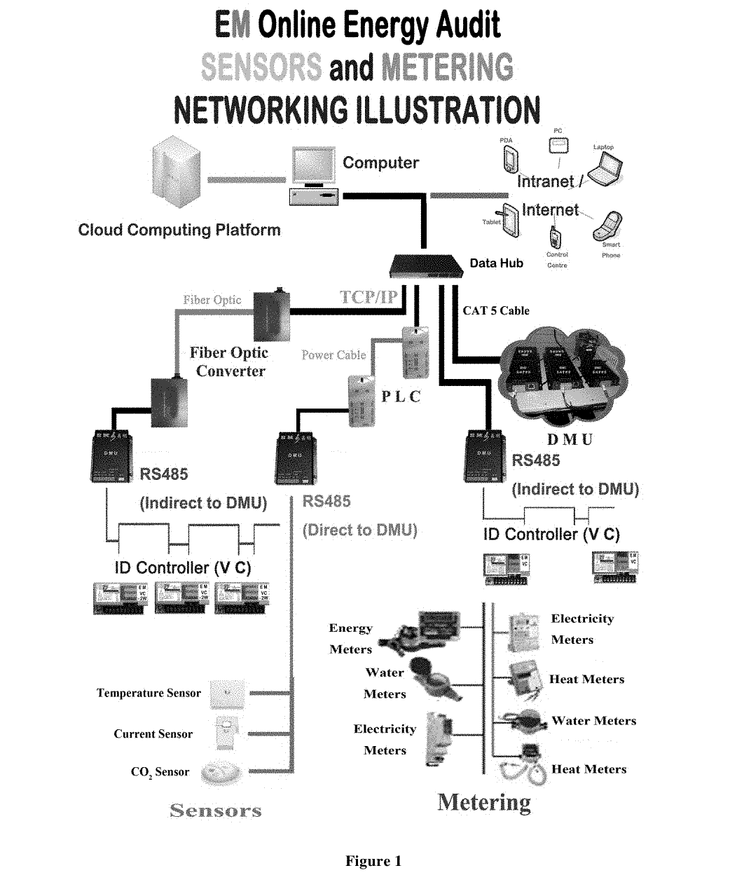

Referring to FIGS. 1, which illustrates a block diagram of an example online energy audit system of the present disclosure. The example online energy audit system or the building/property energy auditing and control management system can handle online data using a variety of protocols (RS232, RS485, MODBUS, RTU, BACnet, Lonworks, KNX, M-BUS, or CAN bus . . . etc), thus there are two or more protocol (RS232, RS485, MODBUS, RTU, BACnet, Lonworks, KNX, M-BUS, or CAN bus . . . etc) coexistence of multiple control devices. According to embodiments of the present invention, it can deal integration of various subsystems, and build online energy audit and control management comprising thereof, and you can use a single controller to handle the building/property data, thus enhancing system scalability and stability, which is formed with stable drive circuit design. It is replace or combine the traditional protocol communication and data control centre which can be control all the Building/Property Device direct or indirect using RS232, RS485, MODBUS, RTU, BACnet, Lonworks, KNX, M-BUS, or CAN bus . . . etc communication protocol and output with Transmission Control Protocol TCP/IP or User Datagram Protocol UDP/IP of dedicated or tailor-made format. That mean we can monitor and controlling the entire devices (Sensors: temperature, humidity, pressure, door, CO2, water flood and flood probes; Access Meters: water, gas, electricity, heat; Machinery monitoring: dry contacts, PLC—programmed logic controller; I/O for buttons and indicators: lighting . . . etc; Air Conditioning Control: motorize valve, fan coil unit, AHU, PAU . . . etc; energy consumption metering/billing . . . etc) function through the DMU (Device/Data Management Unit). The DMU control module is connected to the building's devices and sends control signals to read and write it. The entire building's devices can be adjusted via the DMU control module; the said DMU control module includes 2 MPU for different function. One was for the networking management; another one was for the data and command processing, also main control chip is IAP technology of single-chip to speed up the data transmission, plus built-in RAM and FLASH data storage device; the data transmission module is direct and/or indirectly connected to the IoT and connected to a remote computer management system via the DMU; the data transmission module receives the control signal from the remote computer management system and feeds back the entire building's devices information of data, status and command sent by the DMU control module to the computer management system. This invention provides an IoT and the core technology was called Electromechanical to Internet of Things (EM2IoT) intelligent the entire building's devices (Sensors: temperature, humidity, pressure, door, CO2, water flood and flood probes; Access Meters: water, gas, electricity, heat; Machinery monitoring: dry contacts, PLC—programmed logic controller; I/O for buttons and indicators: lighting . . . etc; Air Conditioning Control: motorize valve, fan coil unit, AHU, PAU . . . etc; energy consumption metering/billing . . . etc) and relevant control system that could be applied to all the building devices supply networks with wide scope of application and convenience for promotion.

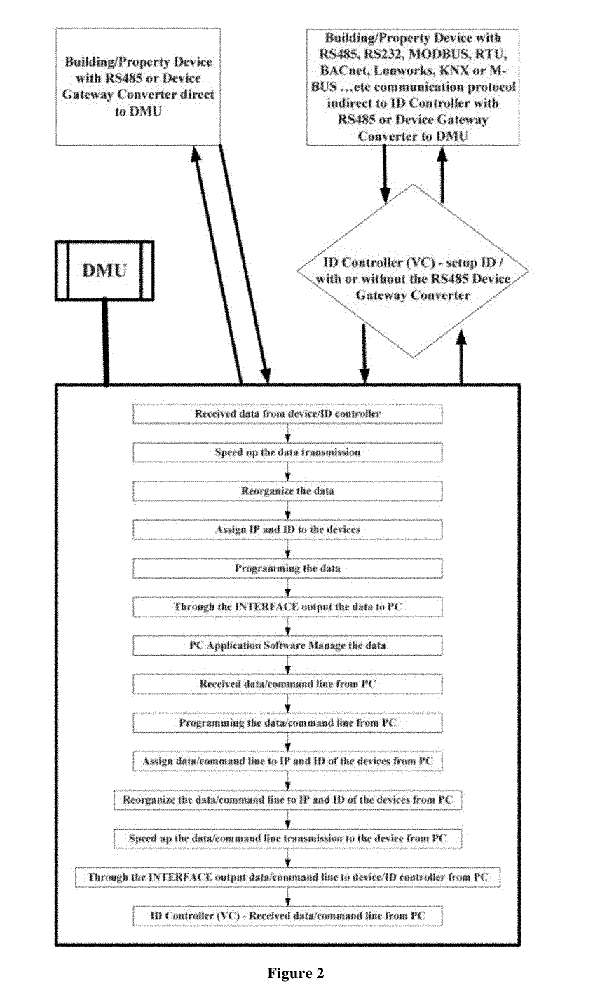

As shown in FIG. 2, the data packages received and sent by the data concentrator are encrypted by the DMU control module. The signal transmitter packs the signal during projection, while the signal receiver up-on receiving the external signal, unpacks the signal into executable operation command, and transmits the command to the DMU control module through data command bus for decryption and operation. DMU control module also consists of RAM and FLASH program memory to store the control program in the DMU control module. Through the program designation in the RAM and FLASH program memory, the device finishes the signal receiving and feedback processing and stores the charging command in the RAM and FLASH data memory. The RAM and FLASH data memory can also store IP/ID, user ID, user's password, data, time, command, system log, error, schedule, working conditions, operation, database backup and restore of the entire building's devices, etc.

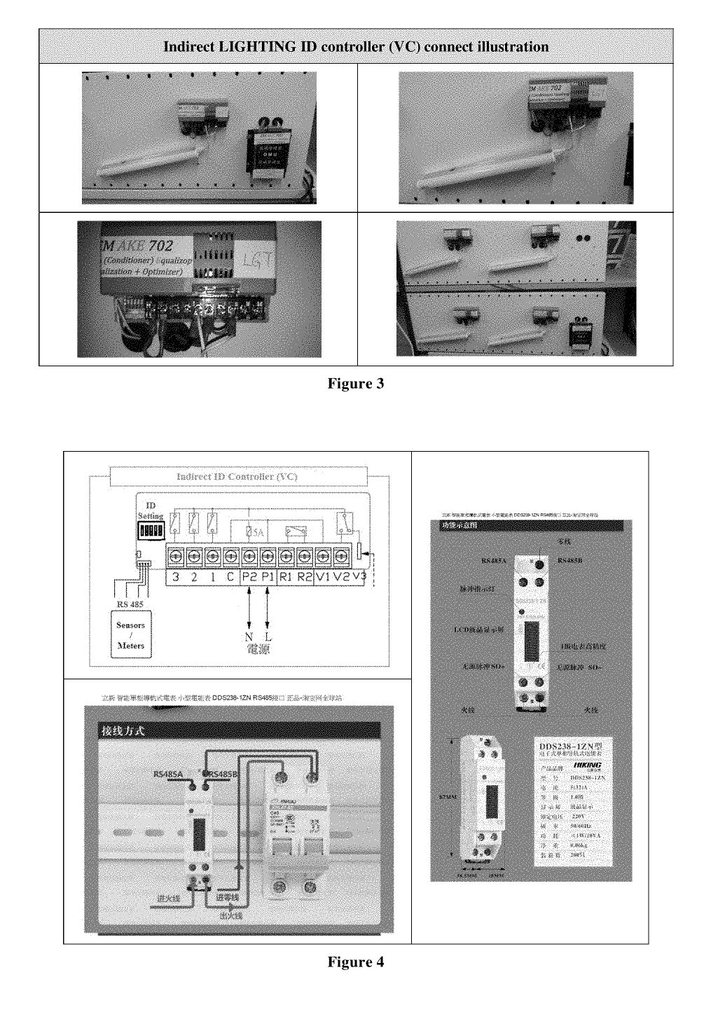

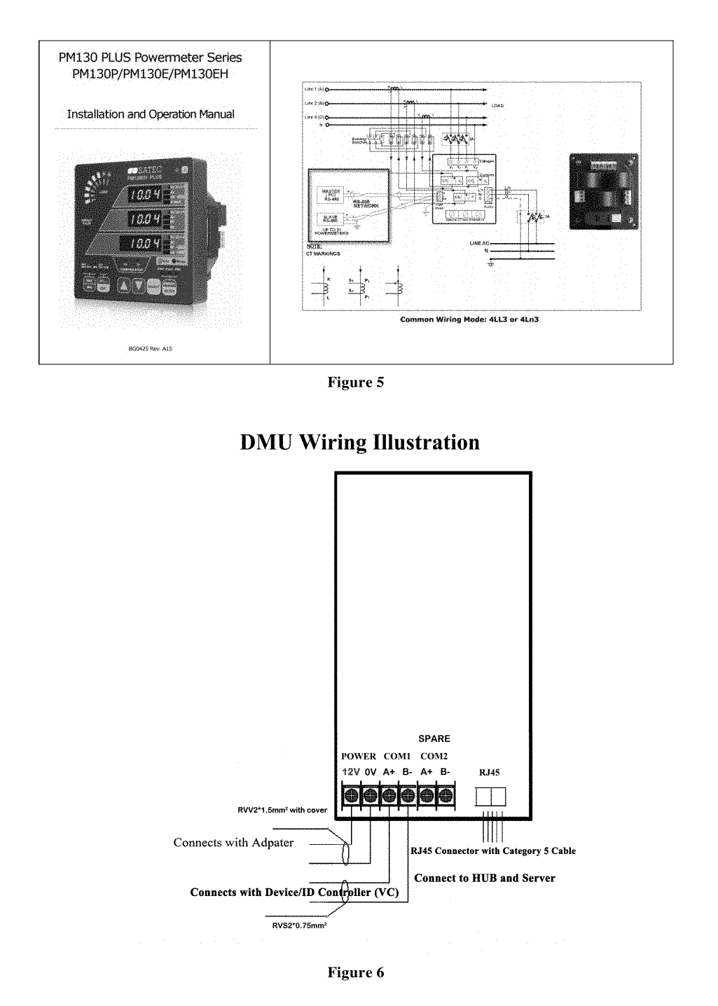

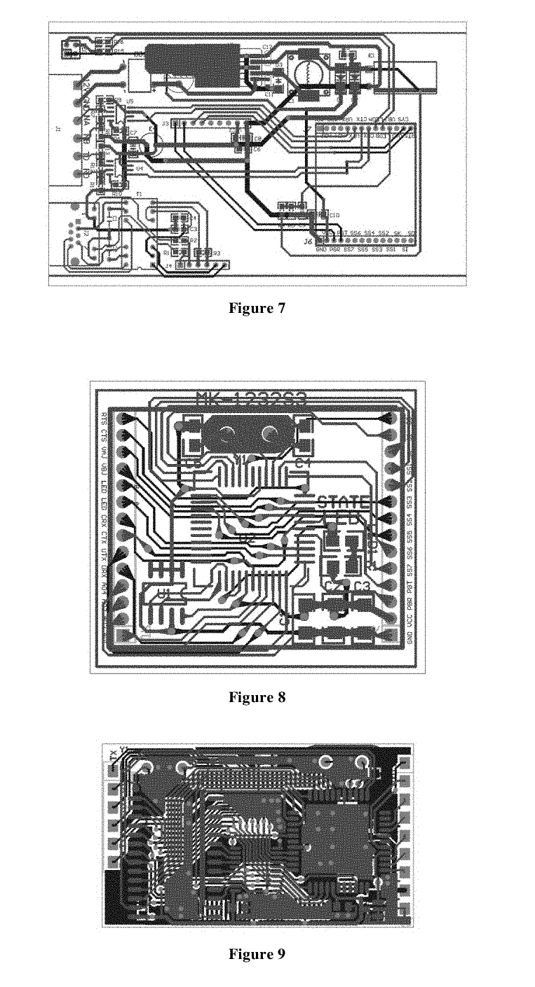

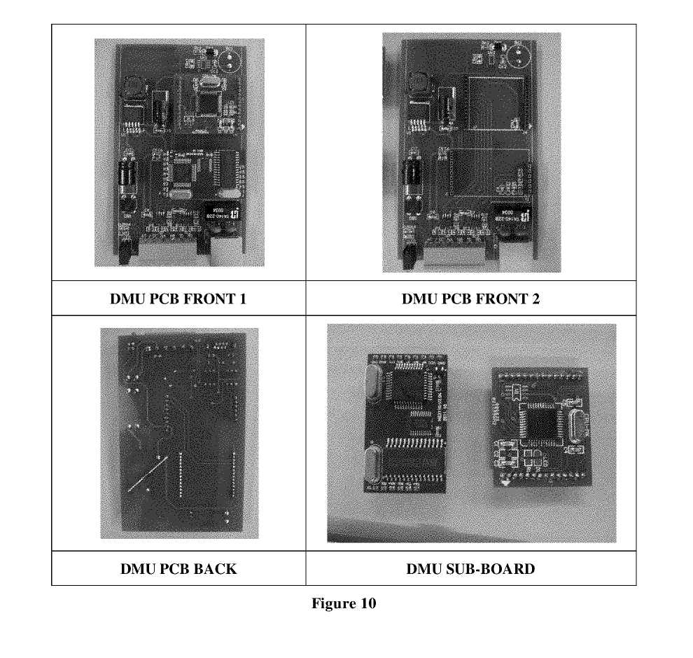

As shown in FIGS. 3, 04 and 05, the DMU control module connected direct and/or indirect to the entire building's devices, which is connected direct and/or indirect to control the entire building's devices; the DMU control module is connected to the entire building's devices through the unique MPU program using RS232, RS485, MODBUS, RTU, BACnet, Lonworks, KNX, M-BUS, or CAN bus . . . etc communication protocol and output with Transmission Control Protocol TCP/IP or User Datagram Protocol UDP/IP of specific format; DMU control module connects to the Sensors: temperature, humidity, pressure, door, CO2, water flood and flood probes; Access Meters: water, gas, electricity, heat; Machinery monitoring: dry contacts, PLC—programmed logic controller; I/O for buttons and indicators: lighting . . . etc; Air Conditioning Control: motorize valve, fan coil unit, AHU, PAU . . . etc; energy consumption metering/billing . . . etc; DMU control module connects to the RAM and FLASH data memory and store IP/ID, user ID, user's password, data, time, command, system log, error, schedule, working conditions, operation, database backup and restore of the entire building's devices, etc.

This invention presents unique DMU using 2 MPU for different function. One was for the networking management; another one was for the data and command processing. DMU also can be upgrade the firmware online to suitable for different protocol format and device requirement.

Therefore the DMU have unique function and feature as below:
Online/Remote upgrade system software;
Transfer data directly through the Internet to the cloud Server, save the local PC and system processing;
Can collect many different device of the protocol at the same time;
Online/Remote configure the protocols and IP/ID addresses of various device at the same or different systems;
Collecting concurrency data for accurate set of data at the same time for analysis.

As shown in FIG. 2, the received and sent data package of data concentrator is the encoded one of DMU control module. Signal transmitter packs signal while dispatching signal, after signal receiver taking the signal, it unpacks signal and transforms it to operational command for execution and transmits it via data command bus to DMU control module for decoding and operation. The RAM and FLASH program memory in DMU control module is used for storing control program operating in DMU control module. By appointing program in RAM and FLASH program memory, the entire building's devices can receive and feedback signal and store received command in MPU data memory, and MPU data memory can also store data like IP/ID, user ID, user's password, data, time, command, system log, error, schedule, working conditions, operation, database backup and restore of the entire building's devices.

This invention, as shown in FIG. 2, provides a control system to control the IoT intelligent the entire building's devices. The control system consists of number of IoT intelligent DMU and data concentrator and distant computer control system. The implementation mode of control system described in this example is simple, only with one data concentrator in control system. For the entire building's devices network, the linked data concentrators with use any DMU can form an IoT. Each IoT intelligent DMU is a node in control system. By collecting data of many nodes, data concentrator will transmit data to computer control system via interface of IoT with internet. According to various application situations, the interface of IoT can be selected from dial interface of phone line, fiber broadband interface, ADSL interface and GPRS interface. The current analysis of popularity of internet interface shows that the fiber broadband interface and ADSL interface can be more practical, so these two interfaces are more helpful for application of this invention generated technical program.

The data on internet and IoT transmitted by IoT intelligent DMU is required to be encoded, while its cipher key can be set by user admin and changed at all time and updated into DMU. As cipher key is changed, computer management system will send a packed command of cipher key modification to DMU, and signal receiver in data transmission module will unpack it and revert it to operable command of cipher key modification and transmit to DMU controller with realization of cipher key update.

The invention provides an IoT/EM2IoT intelligent DMU, including 2 MPU for different function. One was for the networking management; another one was for the data and command processing, also main control chip is IAP technology of single-chip, plus built-in RAM and FLASH data storage device to speed up the processing; the data transmission module is direct and/or indirectly connected to the IoT/EM2IoT and connected to a remote computer management system via the DMU; the data transmission module receives the control signal from the remote computer management system and feeds back the entire building's devices information of data, status and command sent by the DMU control module to the computer management system. This invention provides an IoT and the core technology was called Electromechanical to Internet of Things (EM2IoT) intelligent the entire building's devices (Sensors: temperature, humidity, pressure, door, CO2, water flood and flood probes; Access Meters: water, gas, electricity, heat; Machinery monitoring: dry contacts, PLC—programmed logic controller; I/O for buttons and indicators: lighting . . . etc; Air Conditioning Control: motorize valve, fan coil unit, AHU, PAU . . . etc; energy consumption metering/billing . . . etc) and relevant control system that could be applied to all the building devices supply networks with wide scope of application and convenience for promotion. The DMU control module is connected to and sends control signals to the various devices in the building. The DMU can be adjusted various devices in the building on the DMU control module, which includes built-in RAM and FLASH data memory; the data transmission module is direct and/or indirectly connected to the IoT, and the remote computer management system through the IoT/EM2IoT. The data transmission module receives control signal from the remote computer management system while feeding the data of the various devices in the building sent by the DMU control module back to the computer management system; the data transmission module consists of signal transmitter and receiver, which exchanges data with the DMU control module through the data command bus. The signal transmitter is connected with the data concentrator through wired or wireless way, while the data concentrator is connected to the internet through network communication protocol, sending the various devices in the building statuses collected from the various devices in the building to the computer management system through internet in the form of data package; the DMU control module adjusts and encrypts the data in the built-in RAM and FLASH data memory, and then sends the encrypted data packages to the internet through the signal transmitter in the data transmission module according to the designated communication protocol. The data packages are then forwarded to the computer management system through internet.

In some embodiments, the control signal is sent to the data concentrator by the said computer management system via the Internet in the form of data packets. The data concentrator transmits the received control signal to the data transmission module on the DMU in a wired or wireless manner.

In some embodiments, the said data command bus using RS232, RS485, MODBUS, RTU, BACnet, Lonworks, KNX, M-BUS, or CAN bus . . . etc communication protocol and output with Transmission Control Protocol TCP/IP or User Datagram Protocol UDP/IP of predetermined format.

In some embodiments, the said wireless transmission mode could be Wi-Fi signal, infrared signal, photoelectric signal, ultrasonic signal, microwave signal, or GPRS signal when we plug in the selected or necessaries' tools (bought by the open markets); the wired transmission mode could be optic fiber transmission, power line carrier, RS232, RS485, MODBUS, RTU, BACnet, Lonworks, KNX, M-BUS, or CAN bus . . . etc (need to loading the different firmware to the selected DMU).

In some embodiments, Data packets received and transmitted by the said data concentrator are the one encrypted by the DMU control module; the signal is packed by the signal transmitter when transmitted. After receiving the external signal, the signal receiver unpacks and converts the signal into executable instructions which are transmitted to the DMU control module to be decrypted via the data command busbar and to be operated.

In some embodiments, the said DMU control module further includes RAM and FLASH program memory for storing the control program operated in the DMU control module and specifying the program in the RAM and FLASH program memory to make the DMU complete the processing work of signal reception and the feedback.

In some embodiments, the said DMU control module mainly includes 2 MPU for different function. One was for the networking management; another one was for the data and command processing, also main control chip is IAP technology of single-chip, plus built-in RAM and FLASH data storage device to speed up the processing; the data transmission module is direct and/or indirectly connected to the IoT/EM2IoT and connected to a remote computer management system via the DMU; the data transmission module receives the control signal from the remote computer management system and feeds back the entire building's devices information of data, status and command sent by the DMU control module to the computer management system. This invention provides an IoT and the main technology was called Electromechanical to Internet of Things (EM2IoT) intelligent the entire building's devices (Sensors: temperature, humidity, pressure, door, CO2, water flood and flood probes; Access Meters: water, gas, electricity, heat; Machinery monitoring: dry contacts, PLC—programmed logic controller; I/O for buttons and indicators: lighting . . . etc; Air Conditioning Control: motorize valve, fan coil unit, AHU, PAU . . . etc; energy consumption metering/billing . . . etc) and relevant control system that could be applied to all the building devices supply networks with wide scope of application and convenience for promotion. The DMU control module is connected to and sends control signals to the various devices in the building. The DMU can be adjusted various devices in the building on the DMU control module, which includes built-in RAM and FLASH data memory; the data transmission module is direct and/or indirectly connected to the IoT, and the remote computer management system through the IoT/EM2IoT. The data transmission module receives control signal from the remote computer management system while feeding the data of the various devices in the building sent by the DMU control module back to the computer management system; the data transmission module consists of signal transmitter and receiver, which exchanges data with the DMU control module through the data command bus. The signal transmitter is connected with the data concentrator through wired or wireless way, while the data concentrator is connected to the internet through network communication protocol, sending the various devices in the building statuses collected from the various devices in the building to the computer management system through internet in the form of data package; the DMU control module adjusts and encrypts the data in the built-in RAM and FLASH data memory, and then sends the encrypted data packages to the internet through the signal transmitter in the data transmission module according to the designated communication protocol. The data packages are then forwarded to the computer management system through internet.

In some embodiments, the said control system comprises at least one data concentrator and a remote computer management system, wherein each IoT intelligent DMU is used as a node in the control system; the node is connected to the data concentrator and transmits the data of its own to the data concentrator; after collecting the data from multiple nodes, the data concentrator is connected to the Internet via the interface of IoT and transmits the data to the computer management system.

In some embodiments, said interface of the IoT is any one of the dial-up interface of telephone line, optical fiber broadband interface, ADSL interface and GPRS interface.

In some embodiments, the said computer management system is integrated with unique management system, wherein the unique management system comprises:
Building/Property Device with RS485 or Device Gateway Converter direct to DMU OR Building/Property Device with RS232, RS485, MODBUS, RTU, BACnet, Lonworks, KNX, M-BUS, or CAN bus . . . etc communication protocol indirect to ID Controller with RS485 or Device Gateway Converter to DMU
ID Controller (VC—Variety of Control)—setup ID/with OR without the RS485 Device Gateway Converter
Received data from device/ID controller
Speed up the data transmission
Reorganize the data
Assign IP and ID to the devices
Programming the data
Through the INTERFACE output the data to PC
PC Application Software Manage the data
Received data/command line from PC
Programming the data/command line from PC
Assign data/command line to IP and ID of the devices from PC
Reorganize the data/command line to IP and ID of the devices from PC
Speed up the data/command line transmission to the device from PC
Through the INTERFACE output data/command line to device/ID controller from PC
ID Controller (VC)—Received data/command line from PC.

The Online Energy Audit System (OEA) comes with a software part, which is devised for the analysis and monitoring of the building energy status. The system enables to analysis the energy status from various perspectives by easy way. System features include DMU or devices' IP/ID, user ID, user's password, data, time, command, system log, error, schedule, working conditions, operation, database backup and restore. A multitude of reports can then be produced so as to fully understand and assess how energy is used within the building. EM also provides a web-based platform for all users to view real time energy status of any building at any location. Energy information of major facilities and systems are collected through the DMU. Which installed with reporting and analysis software, it also creates a platform to fulfill the demand of energy monitoring, reporting, and data storage for up to the storage device to fulfill requirements of Online Energy Audit. The building operator and facility management can easily consolidate energy data for monitoring, analysis, and sharing analytic data for third-party control and operation. Details and reports can be printed and emailed for further uses. The main function of the software were: Report Generation; Comparing Energy Saving; Comprehensive Energy Data Record; Remote Access, Anywhere, Anytime; Continuous Monitoring and Improvement; Web portal—Real time energy monitoring . . . etc

Data used to realize functions of management various devices in the building setup, location setup, various devices in the building type setup, user setup (different level, location, devices and authority . . . etc), administrator setup, backup setup and energy audit report setup . . . etc Also the main special function was: Report Generation; Comparing Energy Saving; Comprehensive Energy Data Record; Remote Access, Anywhere, Anytime and Continuous Monitoring and Improvement . . . etc

Energy audit report generation: used to compile the user's request energy audit type of data information, energy audit type by time, by location, by daily, monthly, and annual report . . . etc All by the client customer made for the style and type as per different country and location requirement of the energy audit.

Compared to current technologies, the advantages of the invention include: realizing the each and every terminal equipment's control and communication of the application of IoT/EM2IoT on various devices in the building control system. Through the connection of IoT/EM2IoT, the connection between the control terminal and various devices in the building is no longer limited to the point-to-point control. It realizes the remote control of management, analysis and monitoring of the energy usage in the building. The system enables to analysis the energy usage from various perspectives by easy way. System features include DMU or devices' IP/ID, user ID, user's password, data, time, command, system log, error, schedule, working conditions, operation, database backup and restore. A custom made of reports can be produced as per different queries to fulfill any requirement in different country in different request. Also easy understand and assess how energy is used within the building. In addition, the invention provides IoT/EM2IoT intelligent devices in the building and relevant control system that could be applied to all the devices in the building with wide scope of application and convenience for promotion.

In some embodiments, a first processing unit receives from equipments within a Building/Property a first management data having variety of protocols (RS232, RS485, MODBUS, RTU, BACnet, Lonworks, KNX, M-BUS, or CAN bus . . . etc) and a second management data having Electromechanical to Internet of Things (EM2IoT) communication protocol via the Ethernet communication interface and converting the first management data and the second management data to EM's System common communication layer data; a second processing unit converting the EM's System common communication layer data to commissioning common communication layer data; and converting the commissioning common communication layer data to commissioning common communication layer message having protocol for transmission and output with Transmission Control Protocol TCP/IP or User Datagram Protocol UDP/IP of predetermined format. That mean we can monitor and controlling the entire devices (Sensors: temperature, humidity, pressure, door, CO2, water flood and flood probes; Access Meters: water, gas, electricity, heat; Machinery monitoring: dry contacts, PLC—programmed logic controller; I/O for buttons and indicators: lighting . . . etc; Air Conditioning Control: motorize valve, fan coil unit, AHU, PAU . . . etc; energy consumption metering/billing . . . etc) function through the DMU to an external control server. And the drawings with brief description show as below:
1. Building/Property Device with RS485 or Device Gateway Converter direct to DMU OR Building/Property Device with RS232, RS485, MODBUS, RTU, BACnet, Lonworks, KNX, M-BUS, or CAN bus . . . etc communication protocol indirect to ID Controller with RS485 or Device Gateway Converter to DMU
2. ID Controller (VC—Variety of Control)—setup ID/with OR without the RS485 Device Gateway Converter
3. Received data from device/ID controller
4. Speed up the data transmission
5. Reorganize the data
6. Assign IP and ID to the devices
7. Programming the data
8. Through the INTERFACE output the data to PC
9. PC Application Software Manage the data
10. Received data/command line from PC
11. Programming the data/command line from PC
12. Assign data/command line to IP and ID of the devices from PC
13. Reorganize the data/command line to IP and ID of the devices from PC
14. Speed up the data/command line transmission to the device from PC
15. Through the INTERFACE output data/command line to device/ID controller from PC
16. ID Controller (VC)—Received data/command line from PC.

Features set out in the claims hereto (jointly and severally where appropriate) are to form part of this disclosure and are incorporated herein by reference.

While various examples or embodiments have been described herein, it should be appreciated that they are for illustration and are not for scope restriction. It should be appreciated that portions or parts of the various example embodiments can be excerpted for combination and/or mix-and-match where appropriate to form other variants without loss of generality.

1. An online energy audit system based on Electromechanical to Internet of Things (EM2IoT) and for use in a building, comprising at least one versatile device and data management unit (DMU) adapted and configured for connecting, interacting, intercommunicating with each of energy metering devices, energy consuming devices, and/or environmental sensors installed in the building and manipulating first data received and transmitted therebetween by making use protocols including RS232, RS485, MODBUS, RTU, BACnet, Lonworks, KNX, M-BUS, and/or CAN; and for outputting and sending a second data derived from the first data in a dedicated format with TCP/IP protocol and/or UDP/IP protocol to a remote server or control management apparatus for performing system control and data analysis operations for enabling an online and real-time energy audit for the building.

2. An online energy audit system of claim 1, wherein the energy metering devices comprise metering devices for water, gas, electricity, and/or heat; and/or the energy consuming devices comprise machinery monitoring devices including dry contacts, programmed logic controller; I/O devices for buttons and indicators including lighting; air conditioning control devices including motorize valve, fan coil unit, AHU, PAU; and/or the environmental sensors comprise sensors for temperature, humidity, pressure, door, CO2, water flood, and flood probes.

3. An online energy audit system of claim 1, wherein the DMU comprises two MPUs respectively for network management and for data and command processing; and a main control chip adopting IAP technology of single-chip; and a built-in RAM and/or FLASH type data storage device for speeding up data processing and/or storing IP address/ID of each of connected devices or sensors, user ID, user password, energy audit related data, time, command, system log, error code or information, schedule, working conditions, operation, database for backup and restore.

4. An online energy audit system of claim 1, wherein the DMU comprises a ID controller configured for enabling an automatic or manual assignment of IP address and/or ID to each of connected energy metering devices, energy consuming devices, and/or environmental sensors, with or without RS485 device gateway converter.

5. An online energy audit system of claim 1, wherein the DMU comprises a configurable firmware allowing an automatic or manual online/remote modification or upgrade, such that the DMU is able to adapted to any newly installed or modified energy metering devices, energy consuming devices, and/or environmental sensors.

6. An online energy audit system of claim 1, wherein the DMU is configured for connecting concurrently a plurality of energy metering devices, energy consuming devices, and/or environmental sensors for collecting data concurrently from multiple devices and/or sensors of various IP addresses, IDs, and protocols for enhancing data accuracy and analysis base thereon.

7. An online energy audit system of claim 1, further comprising a data hub/data transmission module connected to the remote server or control management apparatus and connected directly and/or indirectly to each of connected energy metering devices, energy consuming devices, and/or environmental sensors via the DMU; the data transmission module receives a control signal from the remote server or control management apparatus and feeds back the second data and/or an information of data, status and command, in relation to each of connected energy metering devices, energy consuming devices, and/or environmental sensors, generated and sent by the DMU to the remote server or control management apparatus.

8. An online energy audit system of claim 7, wherein the second data is encoded by a configurable cipher key stored in the DMU; when the cipher key is changed, the remote server or control management apparatus will send a packed command for modification of the cipher key to DMU, and the packed command will be unpacked and reverted to an operable command of the DMU for modification of the cipher key by the data hub/data transmission module or the DMU.

9. An online energy audit system of claim 1, wherein the DMU is configured for converting each of connected energy metering devices, energy consuming devices, and/or environmental sensors into a thing or node of an Internet of Things (IoT) comprising the remote server or control management apparatus and the DMU, wherein the thing or the node is able to transfer the second data or an energy audit related data to the remote server or control management apparatus without requiring human-to-human or human-to-computer interaction.

10. An online energy audit system of claim 7, wherein the DMU and each of its connected devices and sensors is configured as a node of an Internet of Things (IoT) comprising the remote server or control management apparatus, the data hub/data transmission module, and the DMU, wherein the node is connected to the data hub/data transmission module and transmits the second data or energy audit related data to the data hub/data transmission module; after collecting or receiving data from multiple nodes, the data hub/data transmission module transmits received data to the remote server or control management apparatus in a wired or wireless manner, preferably by optical fiber broadband interface, ADSL interface, and/or mobile interface including GPRS, 3G, and 4G interface.
